(19) United States
(12) Patent Application Publication
(10) Pub. No.: US 2005/0155183 A1
(43) Pub. Date: Jul. 21, 2005

(54) Hinge for a notebook computer

(76) Inventors: Sheng-Nan Lu, Shulin City (TW); Ching-Hsiang Hsu, Shulin City (TW); Tein-Yueh Hsu, Shulin City (TW); Wei-Chun Chen, Shulin City (TW); Wen-Hao Liao, Shulin City (TW); Yao-Tsung Chan, Shulin City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/759,707

(22) Filed: Jan. 16, 2004

(51) Int. Cl. E05D 11/08

(52) U.S. Cl. 16/340

(57) ABSTRACT

A hinge for a notebook computer includes a hinge member and a fastener assembly. The hinge member has a seat with a lateral portion and an upright portion. A hole is defined through the upright portion, and two recesses are defined at an exterior side of the upright portion. A pintle extends through the hole. A nut is threadingly mounted at a first end of the pintle. The fastener assembly has a positioning member provided outside the pintle and between the upright portion and the nut. The positioning member has an aperture corresponding to the pintle. Two protrusions are formed at a surface facing the upright portion and engaged in the recesses in a closed status of the notebook computer. A resilient member is provided outside the pintle and between the positioning member and the nut. Whereby, the hinge has a simplified structure and a low manufacturing cost.

### BACKGROUND OF THE INVENTION

1. Field of the Invention

The present invention relates to a hinge for a notebook computer, and more particularly to a hinge with a simple structure for preventing an LCD monitor from striking a body under an excessive force to fold the notebook computer.

2. Description of Related Art

The versatility of notebook computers, particularly their portability, necessitates protection of the LCD screen and thus they were developed with the LCD screen hinged to a keyboard body whereby the delicate screen face can be protected from impact etc when not in use. It was found in early notebook computers that the raised screen would drop too quickly to the body when the computer was being closed, and the impact of the screen on the keyboard frequently caused damage to the computer. Thus, the notebook computer is generally provided with a hinge which can stop the lowering LCD monitor just prior to the final closed position, whereafter the user can carefully complete closing operation.

With reference to FIGS. 5 and 6, a conventional hinge is composed of a hinge member (30) and a fastener assembly (40). The hinge member (30) has a connecting sheet (31) for being mounted on an LCD monitor (not shown). A seat (32) has a lateral portion for being mounted on a body of the notebook computer, and an upright portion perpendicular to the lateral portion. A pintle (33) extends between the connecting sheet (31) and the upright portion of the seat (32).

The fastener assembly (40) has a first positioning disk (41) and a second positioning disk (42) in turn provided outside the pintle and at an exterior side of the upright portion, wherein the first positioning disk (41) is securely mounted on the upright portion, and the second positioning disk (42) matches the first positioning disk (41). The first positioning disk (41) has at least one lug (411) formed at a surface away from the upright portion of the seat (32), and the second positioning disk (42) has at least one recess (421) defined at a surface facing the first positioning disk (41). When the notebook is in a closed status, the lug (411) is received in the recess (421). The positioning disks (41, 42) are fastened by a nut engaged with a threaded end of the pintle, and a resilient member (43) is provided between the nut and the second positioning disk (41).

Therefore, when a user unfolds the notebook computer, the pintle (33) and the second positioning member (42) are driven by the connecting sheet (31) to rotate about the seat (32). The lug (411) of the first positioning member (41) will be disengaged from the recess (421), and the resilient member (43) is compressed. Then, the LCD monitor can be retained at any desired angle relative to the keyboard under the force of the compressed resilient member (43).

When the user folds the notebook computer, the pintle (33) and the second positioning member (42) can be inversely rotate until the lug (411) is positioned in the recess (421) again. Then, the LCD monitor will not strike the body even if the user folds with an excessive force.

However, the conventional hinge including two positioning members has a complex structure, which has a high manufacturing cost and it is very inconvenient to assemble the hinge.

Therefore, the invention provides a hinge to mitigate or obviate the aforementioned problems.

### SUMMARY OF THE INVENTION

The main objective of the present invention is to provide a hinge for a notebook computer which has a simple structure to prevent an LCD monitor from striking a keyboard body of the notebook computer undergoing an excessive force to fold the notebook computer.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge in accordance with the present invention;

FIG. 2 is a schematic front view of the hinge of the invention;

FIG. 3 is a schematic front view of the hinge in a rotating status;

FIG. 4 is a side view of FIG. 3;

FIG. 5 is an exploded perspective view of a conventional hinge; and

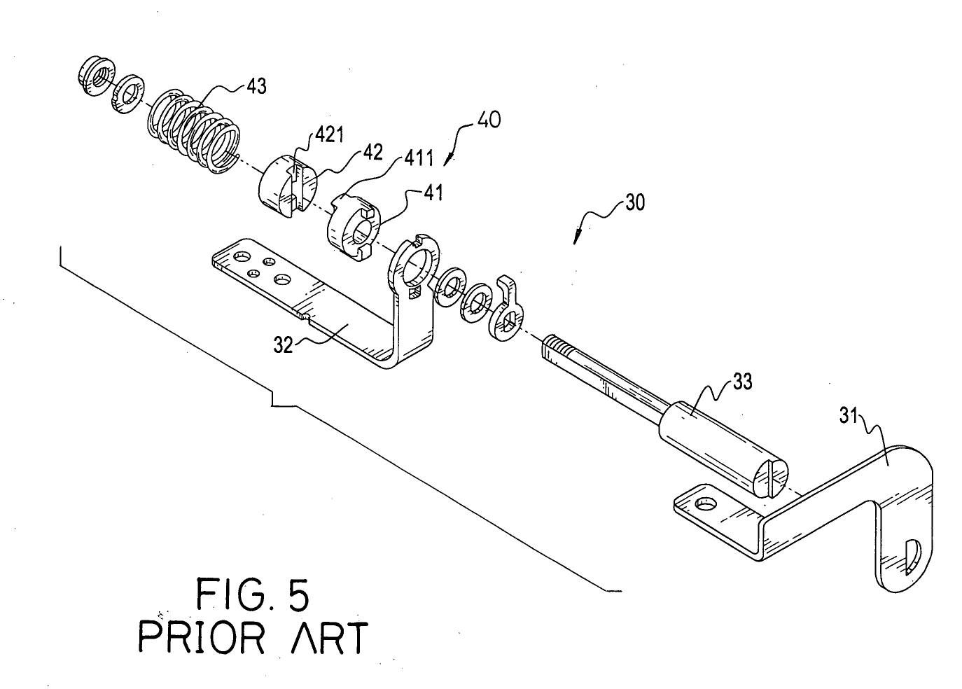

FIG. 6 is a front view of the conventional hinge.

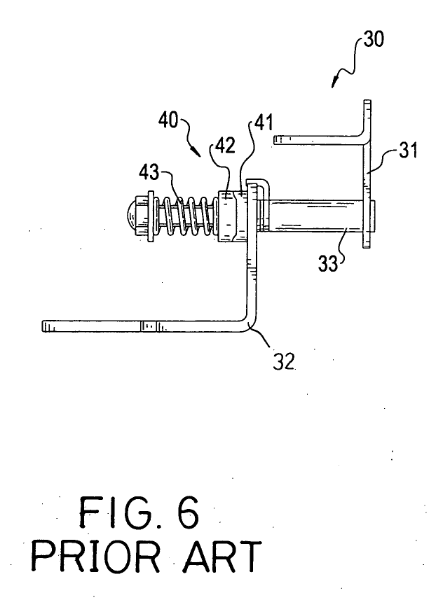

### DETAILED DESCRIPTION OF THE PREFERRED EMBODIMENT

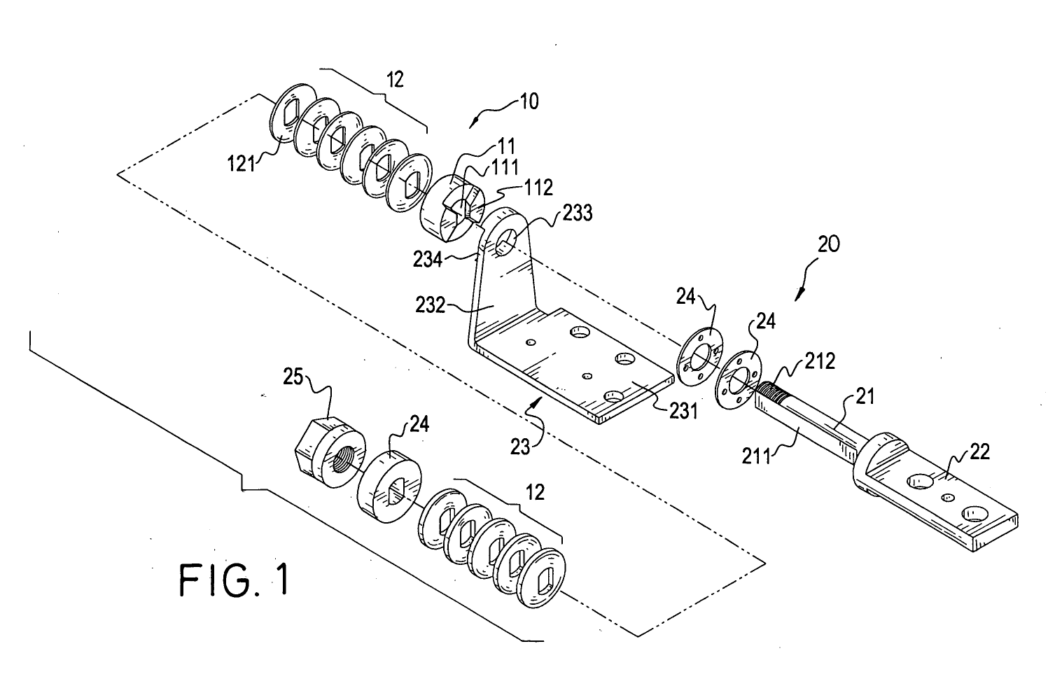

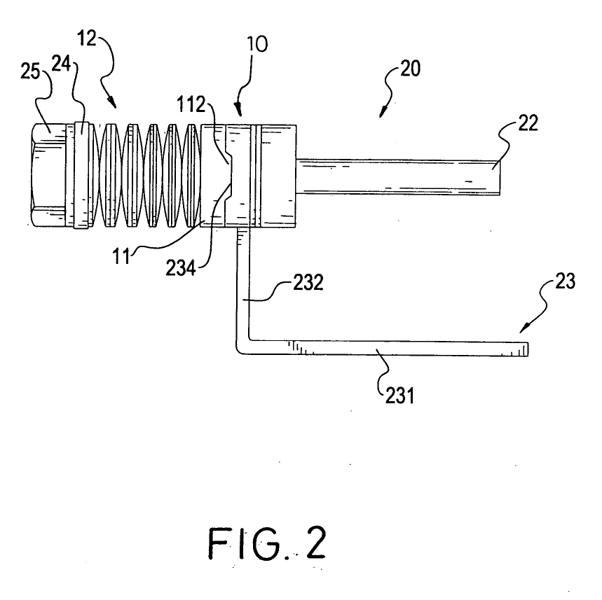

With reference to FIGS. 1-2, a hinge for a notebook computer in accordance with the invention is composed of a hinge member (20) and a fastener assembly (10).

The hinge member (20) has a pintle (21) with a non-circular cross section. In this embodiment, the pintle (21) has two flat surfaces (211) respectively formed at two diametrically opposite sides thereof. An external thread (212) is formed at a first end of the pintle (21). A connecting part (22) is formed at a second end of the pintle (21) and fastened on an LCD monitor (not shown) of the notebook computer.

A seat (23) for being fastened on a body of the notebook computer (not shown) has a lateral portion (231) and an upright portion (232) substantially perpendicular to the lateral portion (231). The upright portion (232) has a hole (233) defined therethrough, and the pintle (21) extends through the hole (233). At least one first washer (24) is provided outside the pintle (21) and between the upright portion (232) and connecting part (22). Multiple recesses (234) are evenly defined at an exterior side of the upright portion (232). In this embodiment, the upright portion (232) has two recesses (234) formed symmetrically at two diametrically opposite sides of the hole (233). A nut (25) is engaged with the external thread (212) at the first end of the pintle (21).

The fastener assembly (10) is composed of a positioning member (11) and a resilient member (12) provided outside the pintle (21) and in turn between the upright portion (232) and the nut (25).

The positioning member (11) has multiple protrusions (112) formed at a surface facing the upright portion (232). In this embodiment, two protrusions (112) are formed at two diametrically opposite sides of the positioning member (11) and respectively positioned in the recesses (234). The outermost surfaces of the protrusions (112) in contact with the innermost surfaces of the recesses (234) are curved surfaces. An aperture (111) with a non-circular cross section corresponding to the pintle (21) is axially defined through the positioning member (11).

The resilient member (12) can be a spring, multiple springs or the like. In this embodiment, the resilient member (12) includes multiple elastic dished disks (121) each with a non-circular opening (not numbered) in series provided outside the pintle (21) with a back-to-back configuration. The axial thicknesses of the elastic dished disks (121) are gradually increased from the positioning member (11) to the nut (25). Namely, the elastic dished disk (121) nearest the positioning member (11) has the smallest thickness, and the elastic dished disk (121) nearest the nut (25) has the biggest thickness. A second washer (241) is provided between the nut (25) and the resilient member (12).

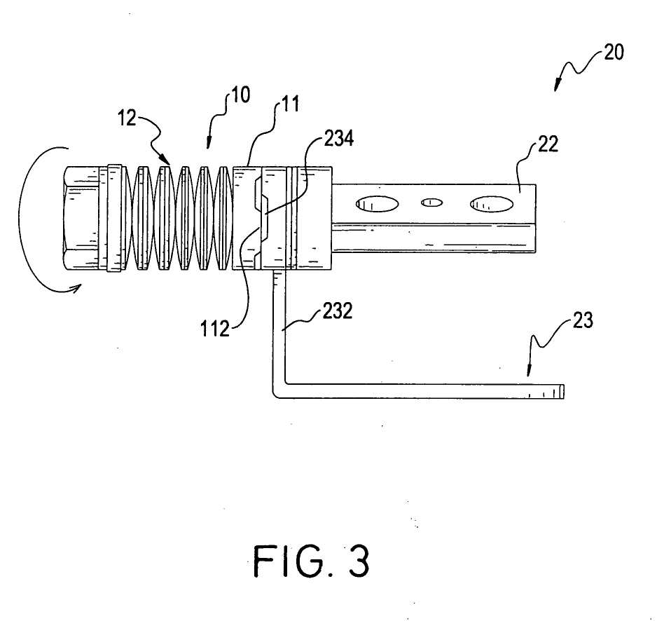

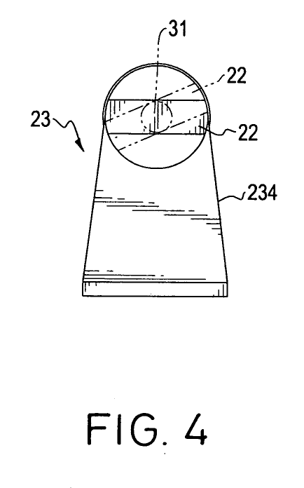

In use, with reference to FIGS. 3 and 4, when a user raises the LCD monitor from the keyboard body, the connecting part (22) and the pintle (21) are driven to rotate about the seat (23). The positioning member (11) is also rotated along with the pintle (21) about the upright portion (232) to disengage the protrusions (112) from the recesses (234). The elastic dished disks (121) are pressed by the positioning member (11) to provide a force to position the LCD monitor at any desired angle. When the user lowers the LCD monitor to inversely rotate the pintle (21), the protrusions (112) on the positioning member (11) will be received in the recesses (234) again to stop the descent to prevent the LCD monitor from striking the body under an excessive force to fold the notebook computer.

Therefore, according to the invention, the hinge is provided with only one positioning member, so the hinge has a simplified structure and a low manufacturing cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A hinge for a notebook computer comprising:
a hinge member having a seat with a lateral portion and an upright portion perpendicular to the lateral portion, the upright portion having a hole defined through the upright portion and at least one recess defined at an exterior side of the upright portion; and a pintle with a non-circular cross section extending through the hole and having an external thread formed at a first end of the pintle, a connecting part formed at a second end of the pintle, and a nut engaged with the external thread at the first end; and
a fastener assembly having a positioning member provided outside the pintle and between the upright portion and the nut, the positioning member having an aperture with a non-circular cross section corresponding to the pintle, and at least one protrusion formed at a surface facing the upright portion and engaged in the at least one recess in a closed status of the notebook computer, and a resilient member provided outside the pintle and between the positioning member and the nut.

2. The hinge as claimed in claim 1, wherein the upright portion of the seat has two recesses defined at two diametrically opposite sides of the hole; and the positioning member has two protrusions formed at two diametrically opposite sides of the aperture and respectively positioned in the recesses in the closed status of the notebook computer.

3. The hinge as claimed in claim 2, wherein the outermost surfaces of the protrusions in contact with the innermost surfaces of the recesses are curved surfaces.

4. The hinge as claimed in claim 1, wherein the resilient member includes multiple elastic dished disks each with a non-circular opening in series provided between the positioning member and the nut with a back-to-back configuration.

5. The hinge as claimed in claim 4, wherein the elastic dished disks are arranged to each have an axial thickness gradually increased from the thickness of the previous elastic dished disk as the arrangement of the elastic dished disks extends from the positioning member to the nut.

6. The hinge as claimed in claim 1 further comprising at least one first washer provided between the upright portion and the connecting part.

7. The hinge as claimed in claim 1 further comprising a second washer provided between the resilient member and the nut.
